(19) United States
(12) Patent Application Publication
(10) Pub. No.: US 2013/0229366 A1
(43) Pub. Date: Sep. 5, 2013

(54) Support for an Optically Bonded Display Device

(71) Applicants: Rajesh Manohar Dighde, Redmond, WA (US); Andrew N. Cady, Kirkland, WA (US); Bernard Maurice Schultz, Bothell, WA (US)

(72) Inventors: Rajesh Manohar Dighde, Redmond, WA (US); Andrew N. Cady, Kirkland, WA (US); Bernard Maurice Schultz, Bothell, WA (US)

(21) Appl. No.: 13/599,635

(22) Filed: Aug. 30, 2012

Related U.S. Application Data
(60) Provisional application No. 61/606,321, filed on Mar. 2, 2012.

(51) Int. Cl. G06F 3/041

(52) U.S. Cl. 345/173

(57) ABSTRACT

Display device support techniques are described. In one or more implementations, an apparatus includes a touch panel assembly and a display housing. The touch panel assembly includes one or more touch sensors and a transparent surface. The display housing secures a display module, the display module optically bonded to the touch panel assembly. A support is disposed to contact the touch panel assembly and the display housing.

### RELATED APPLICATIONS

This application claims priority under 35 U.S.C. Section 119(e) to U.S. Provisional Application No. 61/606,321, filed Mar. 2, 2012, and titled “Screen Edge,” the entire disclosure of which is hereby incorporated by reference.

### BACKGROUND

The configuration of computing device is ever increasing. For example, use of computing devices expanded with the advent of a desktop personal computer. Configurations continued to expand and thus so too did the pervasiveness of computing device in everyday life, such as from the desktop personal computer to laptop computer, netbooks, mobile communications devices such as mobile phones and tablet computers, and so on.

However, as these configurations continue to expand conventional techniques that were utilized to provide display devices associated with the computing devices could be inadequate for these new configurations. For example, conventional display devices in these new configurations could form visual display artifacts during operation and user interaction, which could hinder a user's interaction and experience with the devices.

Furthermore, there is an increasing focus in some instances on making thinner, lightweight and yet robust and durable devices. This often involves thinner components than traditionally used, such as touch panel assemblies, display modules, and so on. These components may be fragile, and therefore techniques may be employed to enhance the robustness of these components. These techniques, however, may cause the devices to have increased sensitivity to assembly and user induced forces during interaction with the device, which may cause display artifacts that may affect a user's interaction and experience with the device.

### SUMMARY

Display device support techniques are described. In one or more implementations, an apparatus includes a touch panel assembly and a display housing. The touch panel assembly includes one or more touch sensors and a transparent surface. The display housing secures a display module, the display module optically bonded to the touch panel assembly. A support is disposed to contact the touch panel assembly and the display housing.

In one or more implementations, a display device includes an external enclosure forming a cavity, a touch panel assembly secured by the external enclosure and defining a first perimeter, and a display housing that secures a display module. The display housing is disposed within the cavity and the display module is optically bonded to the touch panel assembly such that a gap is formed between the display module and the touch panel assembly. A support is disposed within the gap configured to reduce deflection of the display module caused responsive to a pressure applied due to user interact with the touch panel assembly.

In one or more implementations, a display device includes an external enclosure forming a cavity, a touch panel assembly secured by the external enclosure to define a first perimeter, and a display housing that secures a display module. The display housing is disposed within the cavity and forms a second perimeter that is disposed at least partially within the first perimeter. The display module is optically bonded to the touch panel assembly thereby defining a third perimeter disposed at least partially within the second perimeter. A support is disposed between the touch panel assembly and the display housing and between the first and third perimeters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ a display device utilizing the support techniques described herein.

FIG. 2 depicts a system in an example implementation in which manufacture of a display device is shown

FIG. 3 depicts a system in which a top view of the computing device of FIG. 1 that incorporates the display device of FIG. 2 is shown.

FIG. 4 illustrates an example system that includes the support of FIG. 1.

FIG. 5 depicts a system showing an example of the touch panel assembly and display module in greater detail.

### DETAILED DESCRIPTION

Overview

Computing devices may assume a variety of configurations. Additionally, these configurations may utilize a wide range of devices from a variety of different manufacturers, even to form a single product for sale. For example, a manufacturer of a computing device may utilize a variety of different display modules from a variety of different sources. Accordingly, although these display modules may provide similar functionality, the size of the modules may vary, one to another.

Further, construction of the touch and display assemblies during optical bonding may create gaps between underside of touch panel assembly and/cover glass and top of the display module and housing along the perimeter of the display. Due to oversized cover glass/touch module, cantilever action may be encountered during user interaction, which may result in visual artifacts due to flexing a liquid crystal display module in a touch panel device or other display device. These display artifacts can be temporary (e.g., due to user interaction) or permanent (e.g., due to stresses caused during assembly and construction). This is also applicable to the non-touch type interactive devices where the assembly stress/defection may create a permanent visual display artifact.

Display device support and construction techniques are described. In one or more implementations, a support is described that may be utilized in a display device to support a display device and touch panel assembly. For example, the display module (e.g., LCD display module) may be optically bonded to a touch panel assembly. However, there may be size differences in the display module relative to an external enclosure that is configured to retain the display module and touch panel assembly. The gap is cause by optical bonding between touch and display modules. The oversized cover glass/touch panel enhances the stress acting in the gap area due to the cantilever effect, which may cause visual artifacts as describe above.

Accordingly, a support may be disposed within this gap, which may be configured to provide contact between the display housing and the touch panel assembly. Therefore, deflection of or the stress on the display module may be reduced when confronted with pressures applied to the touch panel assembly, e.g., to make a gesture. In this way, visual artifacts produced by the display module responsive to this and other pressures (e.g., pressures cause during manufacture of the display device) may be reduced and even eliminated. Further discussion of these and other techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

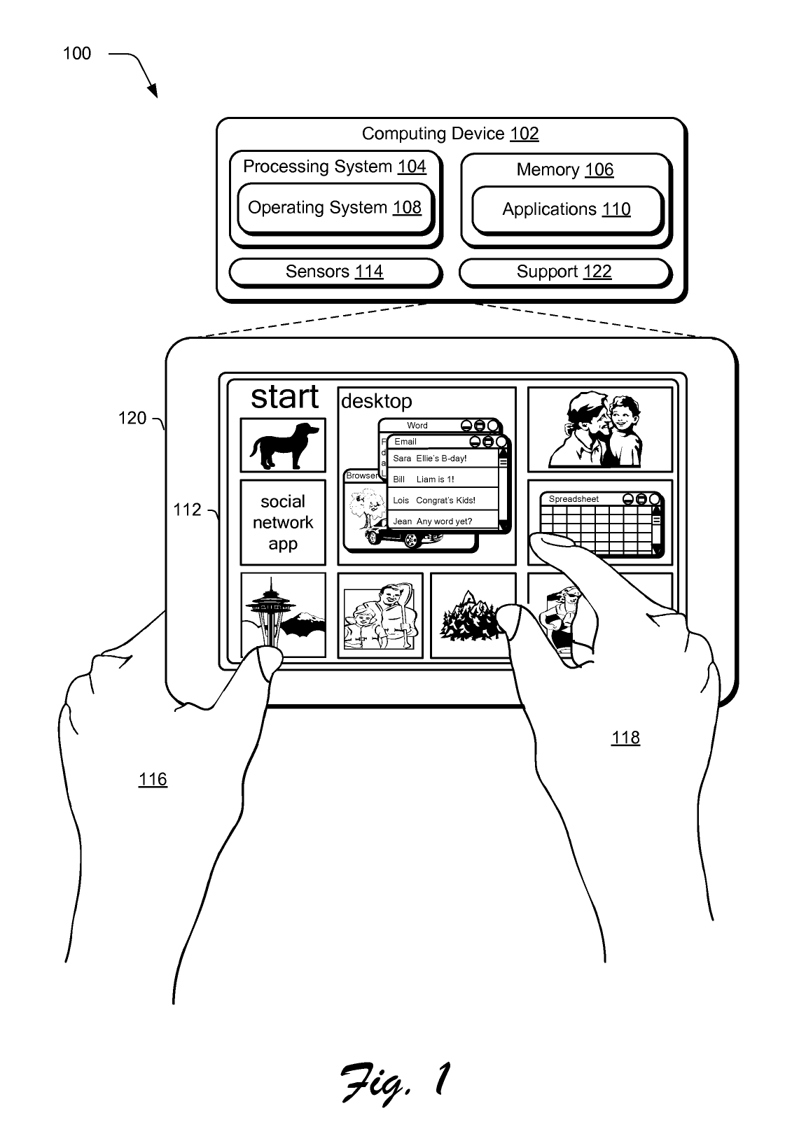

FIG. 1 is an illustration of an environment 100 in an example implementation that is operable to employ techniques described herein. The illustrated environment 100 includes a computing device 102 having a processing system 104 and a computer-readable storage medium that is illustrated as a memory 106 although other confirmations are also contemplated as further described below.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, educational interactive devices, point of sales devices, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on. In addition, it may apply to apparatuses including a plurality of display devices, e.g., a clam shell configuration.

The computing device 102 is further illustrated as including an operating system 108, although other embodiments are also contemplated in which an operating system is not employed. The operating system 108 is configured to abstract underlying functionality of the computing device 102 to applications 110 that are executable on the computing device 102. For example, the operating system 108 may abstract the processing system 104, memory 106, network, and/or display device 112 functionality of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102.

The computing device 102 may support a variety of different interactions. For example, the computing device 102 may include one or more hardware devices that are manipulable by a user to interact with the device, such as a keyboard, cursor control device (e.g., mouse), and so on. The computing device 102 may also support gestures, which may be detected in a variety of ways. The computing device 102, for instance, may support touch gestures that are detected using touch panel functionality of the computing device 102.

The sensors 114, for instance, may be configured to provide touch panel functionality in conjunction with the display device 112. The sensors 114, for instance, may be configured as capacitive, resistive, acoustic, light (e.g., sensor in a pixel), and so on that are configured to detect proximity of an object. An example of this is illustrated in FIG. 1 in which first and second hands 116, 118 of a user are illustrated. The first hand 116 of the user is shown as holding a external enclosure 120 (e.g., housing) of the computing device 102. The second hand 118 of the user is illustrated as providing one or more inputs that are detected using touch panel functionality of the display device 112 to perform an operation, such as to make a swipe gesture to pan through representations of applications in the start menu of the operating system 108 as illustrated. This may also apply to user input with an active or passive stylus.

However, interaction with the display device 112 in this manner may cause visual artifacts to be output by the display device 112 in some conventional optically bonded display devices. For example, a pressure applied by one or more fingers of the user's hand 118 may cause the display device 112 to display a visual artifact. Further, visual artifacts may be caused in a variety of other ways by conventional display devices, such as due to stresses introduced during manufacture of the display device 112, manufacture of the display device 112 as part of the computing device 102 (e.g., within the external enclosure 120), and so on. In such a case, the display artifact may become permanent. Accordingly, techniques are presented herein in which a support 122 is utilized as part of the display device 112, which may be configured to reduce or even eliminate visual artifacts and other complications, further description of which may be found in relation to the following discussion and associated figure.

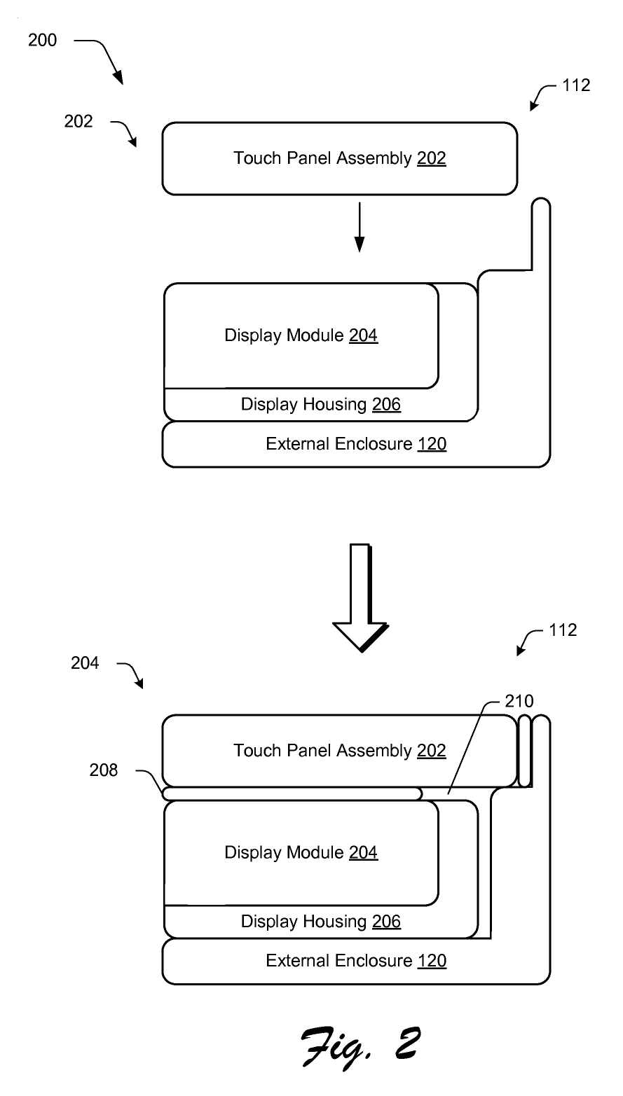

FIG. 2 depicts a system 200 in an example implementation in which manufacture of a display device 112 is shown. This system 200 illustrates manufacture of the display device 112 using first and second stages 202, 204. At the first stage, the external enclosure 120 is illustrated as forming a cavity in which components of the computing device 102 may be disposed within. These components may include the processing system 104, memory 106, display device 112, and other components of the computing device 102.

The display device 112 is illustrated as including a touch panel assembly 202, display module 204, and display housing 206. The touch panel assembly 202 is configured to support touch functionality, such as through use of one or more sensors 114 as described in relation to FIG. 2 to detect proximity of an object.

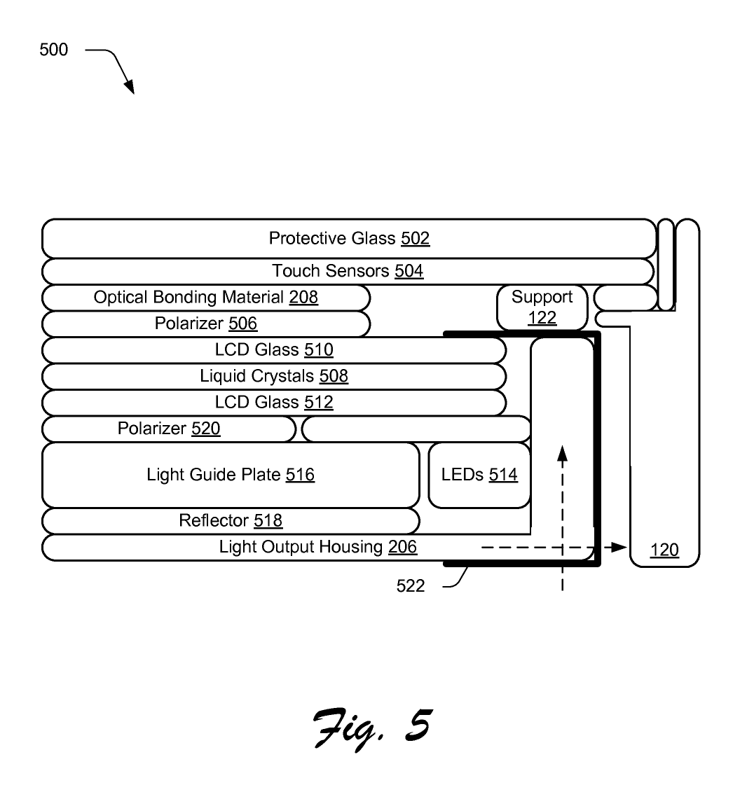

The display module 204 is illustrated as secured within a display housing 206 and installed within the cavity of the external enclosure 120. The display module 204 may be configured in a variety of different ways, such as a liquid crystal display module, an organic light emitting diode (OLED) module, and so on. The display module 204 is further illustrated as disposed within a display housing 206, which is configured to secure components of the display module 204 together, an example of which is shown and described in relation to FIG. 5.

At the first stage 202, the touch panel assembly 202 is illustrated as being positioned over the display module 204 and display housing 206 within the external enclosure 120. At the second stage 204, the touch panel assembly 202 is optically bonded to the display module 204, e.g., using an optical bonding adhesive 208 or other material. Further, the touch panel assembly 202 is also secured to the external enclosure 120, such as through use of an adhesive between the touch panel assembly and a ledge of the external enclosure 120. In this way, the touch panel assembly 202 is secured to both the external enclosure 120 and the display module 204.

During this manufacture, however, a gap 210 may be formed between the touch panel assembly 202 and the display housing 206. This gap 210 may cause pressure applied to the touch panel assembly 202 (e.g., from a finger of the user's hand 118 of FIG. 1) to be transmitted to the display module 204. This pressure may cause deflections of the display module 204 and therefore output of visual artifacts by the display module 204.

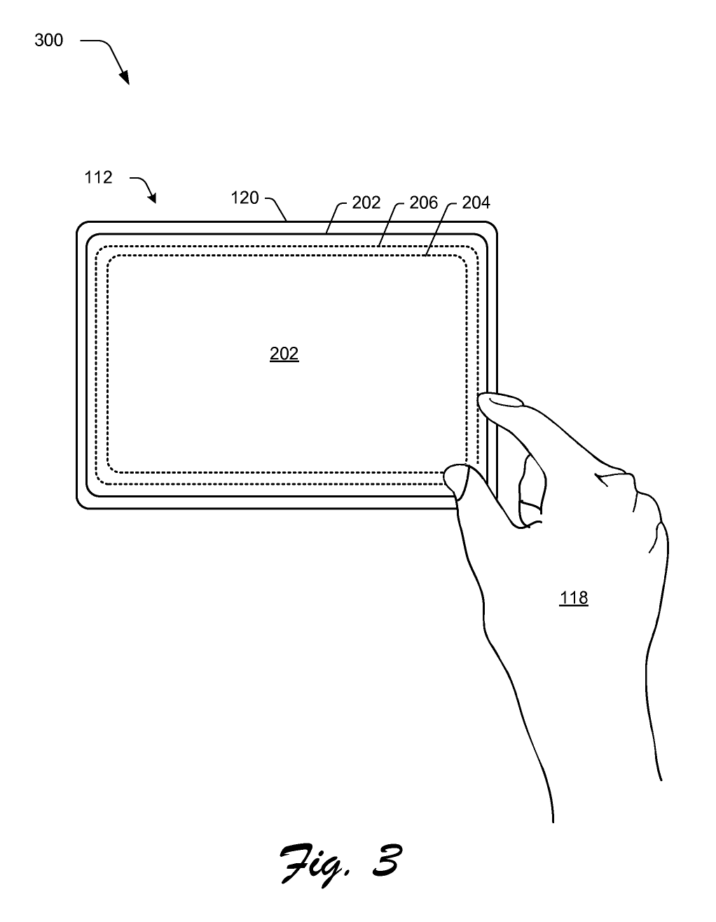

For example, a system 300 in shown in FIG. 3 in which a top view of the computing device 102 of FIG. 1 incorporates the display device 112 of FIG. 2. Securing of the touch panel assembly 202 to the external enclosure 120 is illustrated as defining a first perimeter, such as along the ledge of the external enclosure 120 shown in FIG. 2.

The display housing 206 is disposed within the cavity of the housing 202. As such, an edge along the display housing 206 may be used to define a second perimeter. Additionally, the display module 204 may be optically bonded to portions of the touch panel assembly 202 as shown in FIG. 2. This optical bonding may therefore define a third perimeter that is disposed at least partially within the second perimeter defined by the display housing 206, which is disposed at least partially along the first perimeter defined by the securing of the touch panel assembly 202 to the external enclosure 120.

In conventional techniques, a gap formed between the first and third perimeters, e.g., proximal to the second perimeter, may cause pressure applied at that gap to create visual artifacts. An example of this is illustrated as a pressure applied by a finger of the user's hand 118 although other examples are also contemplated.

Additionally, residual stress may develop as part of the manufacturing process because of the use different materials in an optical bonded display bonding stack, such as a stack that includes the touch panel assembly 202, display module 204, and display housing 206. This may also include applied stresses resulting from the assembly of the bonded devices to the external enclosure 120, such as in thin devices formed to support a hand held form factor.

Further, some display modules may be configured to support wide-angle viewing, such as plane switching, plane line switching, and so on. However, such devices may have increased sensitivity to applied and residual pressures, e.g., stresses. For example, these pressures may change a polarization of embedded liquid crystals and therefore cause visual effects that are viewable by a user of the display device 112, such as light leakage, different color bands, edge pooling, and so forth. These visual effects may be amplified along the edges, e.g., one or more of the perimeters previously described due to applied stress resulting from assembly of components in thin devices. These defects may have a significant impact on a user's experience with the display device 112 and product reliability. Conventional resolution of this issue involved reconstruction of the display module, which can be prohibitively expensive and may be unable to address the assembly caused stresses.

Accordingly, the display device 112 may leverage techniques described herein to reduce and even eliminate these issues. These techniques may include an assembly construction approach, method and materials to solve these issues. For example, the support 122 as described in FIG. 1 may be used to remove unsupported areas in the assembly of bonded displays in the external enclosure. The support 122 may be configured in a variety of ways, such as part of a touch panel assembly 202, display module 204, display housing 206, implemented as a discrete component (e.g., applied by dispense process), and so on, an example of which is described in the following discussion and related figure.

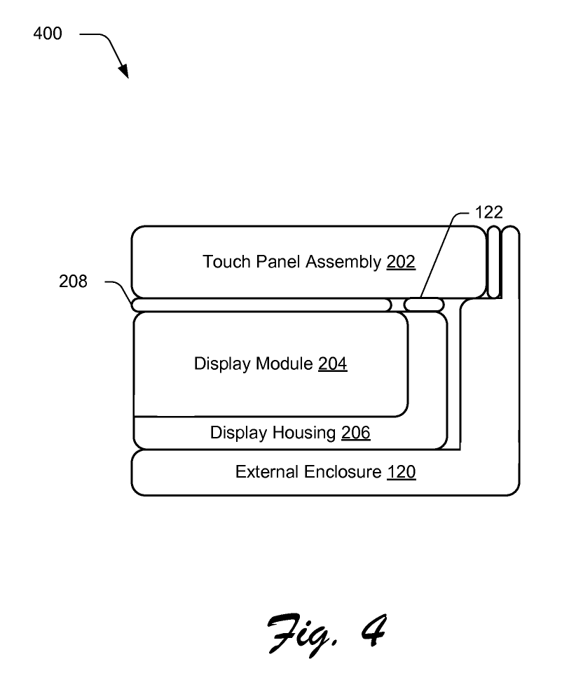

FIG. 4 illustrates an example system 400 that includes the support 122 of FIG. 1. As before, the touch panel assembly 202 is optically bonded to the display module 204 and secured to the external enclosure 120, which defines the first and third perimeters described above. The support 122 is disposed between the first and third perimeters, e.g., proximal to the second perimeter described above, and between the touch panel assembly 202 and the display housing 206. Thus, the support 122 is disposed within the gap 210 described in relation to FIG. 2 and is illustrated in this example as contacting the touch panel assembly 202 and the display housing 206.

The support 122 may be configured and formed in a variety of ways. For example, the support 122 may be added after the touch panel assembly 202 has been optically bonded to the display module 204. This may be performed by inserting the support 122 as a shim in the gap 210 between the touch panel assembly 202 and the display housing 206. In another instance, the display housing 206 may be modified to contact the touch panel assembly 202 and thus the support 122 may be configured as part of the display housing 206. In a further instance, the support 122 may be formed as an adhesive that is configured to harden to act as the support 122.

The support 122 may also be formed before the touch panel assembly 202 is bonded to the display module 204. This may be achieved in a variety of ways. For instance, the support 122 may be formed by dispensing adhesive on an underside of the touch panel assembly 202, which may then harden and act as a support. Material may also be applied using a printing process on the touch panel assembly 202 and/or the display housing 206 to form the support 122. Film adhesives may also be applied to act as the support 122, liquid optical bonding may be utilized, open-cell or closed-cell interface material such as UV-cured adhesives, epoxies, urethanes, acrylic and silicone materials, and so on. Thus, the support 122 may be formed in a variety of ways to reduce stresses that may cause visual artifacts to be formed by the display module 204.

FIG. 5 depicts a system 500 showing an example of the touch panel assembly 202 and display module 204 in greater detail. In this example, the touch panel assembly 202 is formed using a protective glass 502 and touch sensors 504. As before, the touch sensors 504 may assume a variety of configurations, the illustrated example being capacitive but other examples are also contemplated.

The display module 204 includes a polarizer 506 and liquid crystals 508 disposed between two sheets of LCD glass 510, 512. In the illustrated example, an edge lit configuration is shown in which LEDs 514 project light into a light guide plate 516 and employs a reflector 518 to cause the light to pass through a polarizer 520 and through the light crystals 508 described previously.

Components of the display module 204 are disposed within a display housing 206. In the illustrated example, the components are secured to the housing using tape 522, although other examples are also contemplated. As previously described, pressures may be encountered during manufacture of these components. Examples of this are illustrated using phantom arrows showing pressure of the display housing 206 against a side of the external enclosure 120 as well as pressures caused by flexing of the components during installation in the external enclosure 120. Accordingly, the support 122 may be positioned to reduce and even eliminate compressive stresses as described above. Although use of an LCD module is shown, other examples of display device modules are also contemplated.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. An apparatus comprising:
a touch panel assembly including one or more touch sensors and a transparent surface;
a display housing that secures a display module, the display module optically bonded to the touch panel assembly; and
a support disposed to contact the touch panel assembly and the display housing.

2. An apparatus as described in claim 1, wherein the support is configured to reduce deflection of the touch panel assembly in response to contact made against the transparent surface.

3. An apparatus as described in claim 1, wherein the support is configured to reduce appearance of one or more visual artifacts by the display module cause by an application of pressure to the transparent surface.

4. An apparatus as described in claim 1, wherein the support is positioned to extend at least partially around a perimeter defined by a portion of the display module that is optically bonded to the touch panel assembly.

5. An apparatus as described in claim 1, wherein the support is formed using an adhesive.

6. An apparatus as described in claim 1, wherein the external enclosure is configured to support a hand-held form factor.

7. An apparatus as described in claim 1, wherein the display module is configured as a liquid crystal display module or organic light emitting diode (OLED) display module.

8. An apparatus as described in claim 1, wherein the touch panel assembly is configured to detect proximity of one or more objects.

9. An apparatus as described in claim 1, wherein the touch panel assembly is optically bonded to the display module such that the touch panel assembly is secured to the display module and light output by the display module is viewable through the touch panel assembly.

10. A display device comprising:
an external enclosure forming a cavity;
a touch panel assembly secured by the external enclosure and defining a first perimeter;
a display housing that secure a display module, the display housing disposed within the cavity and the display module optically bonded to the touch panel assembly such that a gap is formed between the display module and the touch panel assembly; and
a support disposed within the gap configured to reduce deflection of the display module caused responsive to a pressure applied to the touch panel assembly.

11. A display device as described in claim 10, wherein the support is configured to reduce deflection of the display module to reduce appearance of visual artifacts by the display module responsive to the pressure.

12. A display device as described in claim 10, wherein the support is positioned to extend at least partially around a perimeter defined by a portion of the display module that is optically bonded to the touch panel assembly.

13. A display device as described in claim 12, wherein the gap is defined between the optical bonding of the display module and the touch panel assembly and a portion of the touch panel assembly that is supported by the external enclosure.

14. A display device as described in claim 10, wherein the support is formed an open-cell material, closed-cell interface material, UV-cured adhesive, epoxy, urethane, acrylic, or silicone materials.

15. A display device comprising:
an external enclosure forming a cavity;
a touch panel assembly secured by the external enclosure to define a first perimeter;
a display housing that secure a display module, the display housing disposed within the cavity and forming a second perimeter that is disposed at least partially within the first perimeter and the display module optically bonded to the touch panel assembly thereby defining a third perimeter disposed at least partially within the second perimeter; and
a support disposed between the touch panel assembly and the display housing and between the first and third perimeters.

16. A display device as described in claim 15, wherein the display module is a liquid crystal display module or an organic light emitting diode (OLED) module.

17. A display device as described in claim 15, wherein the support is disposed adjacent to the second perimeter.

18. A display device as described in claim 15, wherein the touch panel assembly is optically bonded to the display module such that the touch panel assembly is secured to the display module and light output by the display module is viewable through the touch panel assembly.

19. A display device as described in claim 15, wherein the support is configured to reduce deflection of the display module responsive to a pressure applied to the touch panel assembly.

20. A display device as described in claim 15, wherein the support is configured to reduce deflection of the display module to reduce appearance of visual artifacts by the display module responsive to a pressure applied to the touch panel assembly.
